(19) United States
(12) Patent Application Publication
(10) Pub. No.: US 2024/0269635 A1
(43) Pub. Date: Aug. 15, 2024

(54) PREVENTION OF SOLID DEPOSITION ON INTERNAL STRUCTURES OF REACTORS

(71) Applicant: C-ZERO, INC., Goleta, CA (US)

(72) Inventors: Brett PARKINSON, Goleta, CA (US); Andrew CALDWELL, Goleta, CA (US); Samuel SHANER, Goleta, CA (US); Eric MCFARLAND, Goleta, CA (US)

(21) Appl. No.: 18/568,514

(22) PCT Filed: Jun. 10, 2022
(86) PCT No.: PCT/US22/33030

§ 371 Date: Dec. 8, 2023

Related U.S. Application Data
(60) Provisional application No. 63/209,631, filed on Jun. 11, 2021.

(51) Int. Cl. B01J 10/00; B01J 8/22; B01J 19/00; B01J 19/26

(52) U.S. Cl. CPC B01J 10/005; B01J 8/22; B01J 19/0026; B01J 19/26; B01J 2219/0263; B01J 2219/0272; B01J 2219/0277

(57) ABSTRACT

A reactor system for high temperature reactions of reactants includes at least one reactant containing carbon. The reactor includes a reactor, a liquid media disposed within the reactor, and a solid carbon reaction product. The liquid media does not react irreversibly with the reactant to form products, and the liquid media wets at least a portion of a surface within the reactor. The solid carbon reaction product does not contact at least the portion of the surface within the reactor where the liquid media wets the portion of the surface within the reactor.

### CROSS-REFERENCE TO RELATED APPLICATIONS

This application claims priority to U.S. Provisional Application No. 63/209,631 filed on Jun. 11, 2021 and entitled, “PREVENTION OF SOLID DEPOSITION ON INTERNAL STRUCTURES OF REACTORS,” which is incorporated herein by reference in its entirety.

### STATEMENT REGARDING GOVERNMENTALLY SPONSORED RESEARCH OR DEVELOPMENT

This invention was made with government support under Grant DE-AR0001194 awarded by the Department of Energy. The government has certain rights in this invention.

### SUMMARY

The present invention relates to methods and reactors for preventing deposition of solid products of gaseous chemical reactions on solid surfaces.

In an embodiment, a method for preventing deposition of solid reaction products from chemical reactions of reactants on solid surfaces within chemical reactors comprises contacting a reactant with a selected liquid media within a reactor, wherein the liquid media does not react irreversibly with the reactant to form products but is of a specific composition selected together with the materials comprising the solid surfaces within the reactor such that the liquid wets the surface of those solid surfaces within the reactor; and preventing production of solid reaction products on the solid surface, or washing off any produced products on the solid surfaces.

In an embodiment, a reactor for high temperature reactions of reactants including at least one containing carbon comprising a liquid media which itself does not react with the reactant gases to form products but which wets the solid surfaces within the reactor with a film of the liquid media on which solid carbon produced in the reaction may be deposited and washed or removed from the solid surface.

In an embodiment, a bubble column reactor system for high temperature reactions of reactants including at least one that contains carbon filled with a high temperature liquid which itself does not react with the reactants to form products but which wets the solid surfaces within the reactor with a film of the liquid media on which solid carbon produced in the reaction may be deposited and washed from the solid surface.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIGS. 1A and 1B schematically illustrates a bubble column with a draft tube coated by a wetting liquid.

FIGS. 2A and 2B schematically illustrates a tube shell reactor with liquid wetted tubes preventing solid deposition.

FIGS. 3A and 3B schematically illustrates a packed bed bubble column reactor whereby the packing is wetted by the liquid preventing solid deposition on the packing.

FIGS. 4A and 4B schematically illustrates a trickle bed reactor whereby the packing is wetted by the downflowing liquid preventing solid deposition on the packing.

FIG. 5 provides photographs of solids wetted by molten metal and not allowing deposition of solid carbon as described in Example 1.

FIG. 6 provides photographs of solids wetted by molten metal which prevented deposition of solid carbon as described in Example 2.

FIG. 7 provides photographs of solids wetted by molten metal which prevented deposition of solid carbon as described in Example 3.

FIG. 8 contains images and elemental mapping analysis of cut section of solid surface wetted by molten metal which prevented deposition of solid carbon with view of underlying surface as described in Example 4.

FIG. 9 provides photographs of wire mesh wetted by molten metal which prevented deposition of solid carbon as described in Example 5.

FIGS. 10A and 10B illustrates photographs of the reactor configuration and draft tube as described in Example 7.

### DETAILED DESCRIPTION

In a variety of chemical processes, gas phase reactants can produce solid products that need to be removed from the reactor without adhering to internal structures within the reactor. The solid phase products can be desired products or side products such as carbon forming due to coking of surfaces. For example, the prevention of carbon deposition (coking) in reactions of hydrocarbons is of major importance in many reactions. It can be difficult to add heat at high temperatures to many hydrocarbon streams without depositing solid carbon on the heat transfer surfaces.

Use of high temperature liquids including molten salts and/or molten metals as heat transfer and reaction media allows facile heat addition to the liquid, and provided the reactants do not react irreversibly with the liquids, the gas phase reactants can be contacted and reacted within the liquid media. It has previously been difficult or impossible to prevent contact between the reactants and solid surfaces within the reactor, and when direct contact is made, a solid product may be deposited on the solid surfaces resulting in fouling or coking that can result in build up over time.

The processes and systems described herein can include specific combinations of liquids and solids selected based on their physical interactions which result in the liquid wetting the solid surfaces and preventing reaction product deposition on such solid surfaces. The processes and systems described herein can also include specific treatments or modifications of the solid surfaces that provide for liquid wetting.

Described herein are methods, materials, and reactors for the prevention of deposition of solid reaction product(s) on reactor internal solid structures. A ubiquitous problem in industrial applications is the fouling and deposition of reactor internal structures or heat exchange surfaces with solid materials produced in chemical reactions. The present systems and methods provide for the selection of liquids stable within the reactor environment and solid structural materials within the reactor that possess physical properties whereby the liquid wets the solid surface everywhere that reactions producing solid products occur within the reactor environment. By wetting the solid surfaces, any solid reaction products are instead deposited on the liquid surface which can be made to circulate to remove the solid reaction products from the solid surfaces and/or reactor, preventing the accumulation of solids.

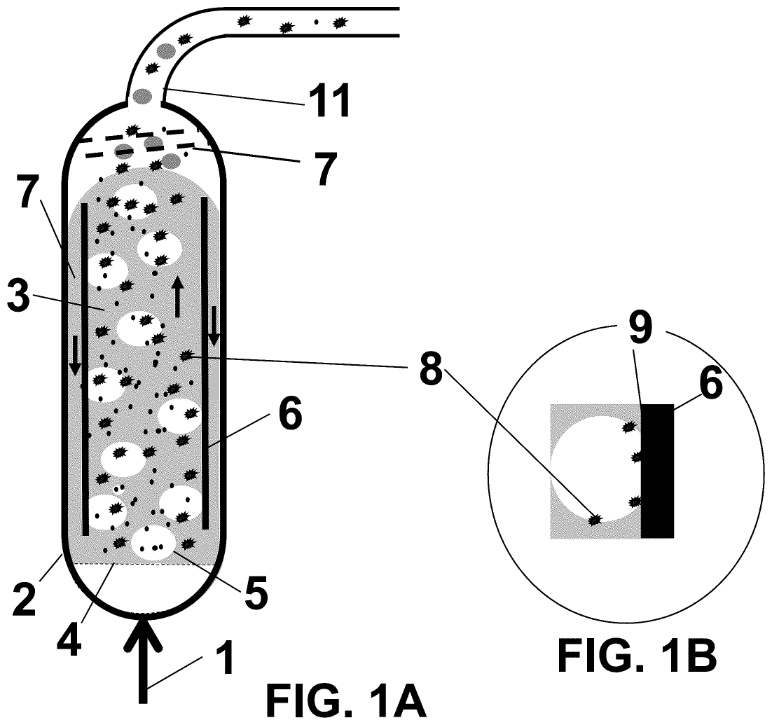

In some embodiments shown in FIG. 1A and FIG. 1B, gas phase reactants 1 can be introduced into a reactor vessel 2 filled with a liquid media 3. The gas forms bubbles 5 by passing through an inlet such as a lance, orifice, or distributor plate 4. The bubbles rise within the reactor vessel 2 and can be confined within a draft tube 6 disposed concentrically within the reactor vessel 2. The bubbles 5 can entrain the liquid and cause the liquid to rise and flow out the top opening of the draft tube 6 and back down the concentric spaces 7 outside the draft tube 6. The reaction produces solid product(s) 8, which are prevented from contacting the solid surface of the draft tube 6 wall by a wetting layer of liquid 9 adhering to the solid surfaces. The reaction products can be passed through a demister 7, which separates liquid droplets entrained in the reaction products and returns the liquid media to the reactor vessel 2. The reaction products can exit the reactor vessel 2 at the outlet 11. In some embodiments, heat can be added or removed from liquid media 3 as the liquid flows down the concentric spaces 7 outside of the draft tube 6.

The draft tube can be constructed from a material stable within the reaction environment and may be solid (e.g., being rolled or extruded) with a smooth surface, or alternatively, it may also be advantageous to use porous material such as a woven, mesh, or otherwise porous structure to facilitate wettability or specific applications. In some embodiments, the draft tube material can be made from tubes, sheets, woven wires, etc., of refractory materials including molybdenum, niobium, tantalum, tungsten, and/or rhenium and any alloy thereof, including combinations thereof. In another embodiment, the draft tube material surface can be made from tubes, sheets, woven wires, etc., of metals, refractory metal-carbides, or oxides of Ni, Fe, Co, molybdenum, niobium, tantalum, tungsten and or/rhenium and their alloys. In some aspects, the materials can be made from ceramics containing, Al₂O₃, SiO₂, ZrO₃, MgO, or graphite. Combinations are also possible. For example, the materials used to form the reactor interior surface, the draft tube, and/or other packings can be formed from materials such as graphite or ceramics that are coated with the metals, oxides, or carbides such as a ceramic or graphite coated with tungsten carbide.

In some embodiments, the liquid can be a molten metal containing one or more elements including Ag, Au, Sb, Sn, Bi, Ni, Cu, Fe, Pt, In, Pb, Pd, Co, Te, Rh and/or Ga, oxides thereof, and their mixtures. In some embodiments, the molten media can comprise a molten salt, a molten metal, or any combination thereof. In some embodiments, the salt mixture comprises one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂), MgCl₂, CaBr₂, MgBr₂ and combinations thereof. In yet another embodiment, the draft tube 6 surface can be prepared in-situ in the reactor by contacting the refractory metal material with a reactive species, either in solution or in the stable state at the operating temperature and pressure of the molten media, introduced into the molten liquid. In other embodiments, the internal structures may be structured packing formed as geometric shapes including tubes, spheres, saddles, rings, and irregularly shaped bodies. The internal structures may also be perforated plates and/or combinations of perforated plates and geometric shapes.

In some embodiments, the reactor can operate at suitable conditions for the desired reaction to occur. In some embodiments, the temperature can be selected to maintain the molten media in the molten state such that the molten media is above the melting point of the composition while being below the boiling point. In some embodiments, the reactor can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. The reactor can operate at any suitable pressure. When small bubbles are desired, the reactor may operate at or near atmospheric pressure such as between about 0.5 atm and about 3 atm, or between about 1 atm and 2.5 atm. In other embodiments, the reactor may operate at higher pressures with an appropriate selection of the reactor configuration, operating conditions, and flow schemes, where the pressure can be selected to maintain a gas phase holdup and superficial gas velocity within the reactor.

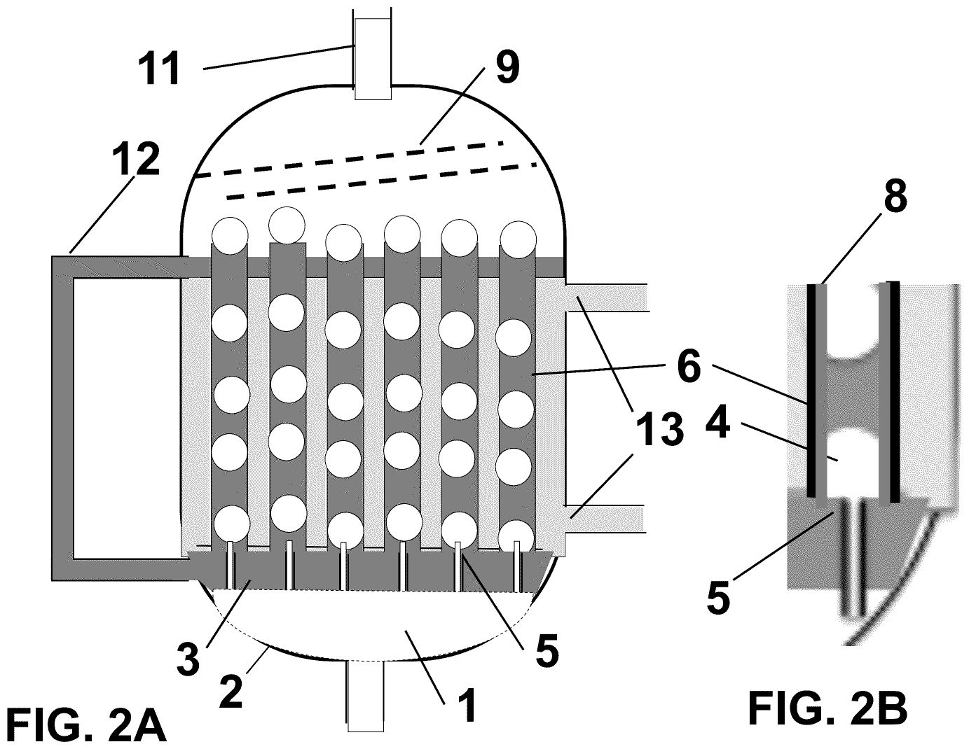

In another embodiment shown in FIG. 2A and FIG. 2B gas phase reactants 1 can be introduced into a reactor vessel 2 filled with a liquid media 3. The gas phase reactants 1 can form bubbles 4 by passing through a nozzle or set of nozzles 5, which release the bubbles 4 into an array of tubes 6. The bubbles rise can be confined within the tube 6, which raises the liquid and causes the liquid to flow out the top opening of the tube 6. The reaction produces solid products, which are prevented from contacting the solid surface of the tube walls 6 by a wetting layer of liquid 8 adhering to the solid surface. The reaction proceeds, and the reaction products can exit the top of the liquid media 3. The reaction products can be passed through a demister 9, which separates liquid droplets entrained in the reaction products and returns the liquid media to the liquid medium in the reactor vessel 2. The reaction products can leave the reactor through an exit 11. The raising of the liquid media 3 in the tubes 6 can cause the liquid to flow through an external circulation loop 12 before passing back to the base of the reactor vessel 2. Heat can be added or removed from the liquid media 3 in the external circulation loop 12 or directly to the tubes 6 through a separate process gas/liquid process fluid 13 flowing around the outside of the tubes 6.

The tubes and tube sheets can be constructed from a material that is stable within the reaction environment and may be solid (e.g., as a rolled or extruded material) with a smooth surface, or alternatively, the material may also be advantageously to a woven, mesh, or otherwise porous structure to facilitate wettability or specific applications. In some embodiments, the draft tube material can be made from tubes, sheets, woven wires, etc., of refractory materials including molybdenum, niobium, tantalum, tungsten, and/or rhenium and their alloys. In another embodiment, the tube and tube sheet material surfaces are made from tubes, sheets, woven wires, etc., of metals, refractory metal-carbides, or oxides of Ni, Fe, Co, molybdenum, niobium, tantalum, tungsten and or/rhenium and their alloys. In some aspects, the materials can be made from ceramics containing, Al₂O₃, SiO₂, ZrO₃, MgO, or graphite. Combinations are also possible. For example, the materials used to form the reactor interior surface, the tubes and tube sheets can be formed from materials such as graphite or ceramics that are coated with the metals, oxides, or carbides such as a ceramic or graphite coated with tungsten carbide.

In some embodiments, the liquid is a molten metal containing one or more elements including Ag, Au, Sb, Sn, Bi, Ni, Cu, Fe, Pt, In, Pb, Pd, Co, Te, Rh and/or Ga, oxides thereof, and their mixtures. In some embodiments, the molten media can comprise a molten salt, a molten metal, or any combination thereof. In some embodiments, the salt mixture comprises one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂), MgCl₂, CaBr₂, MgBr₂ and combinations thereof. In yet another embodiment, the tube or tube sheet material can be prepared in-situ in the reactor by contacting the refractory metal directly with oxygen or carbon in a solid, gaseous, or dissolved state, which is in direct contact with the molten liquid. In other embodiments the internal structures may be structured packing formed as geometric shapes including tubes, spheres, and irregularly shaped bodies. The internal structures may also be perforated plates and combinations of perforated plates and geometric shapes.

In some embodiments, the reactor can operate at suitable conditions for the desired reaction to occur. In some embodiments, the temperature can be selected to maintain the molten media in the molten state such that the molten media is above the melting point of the composition while being below the boiling point. In some embodiments, the reactor vessel 2, can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. The reactor can operate at any suitable pressure. When small bubbles are desired, the reactor may operate at or near atmospheric pressure such as between about 0.5 atm and about 3 atm, or between about 1 atm and 2.5 atm. In other embodiments, the reactor may operate at higher pressures with an appropriate selection of the reactor configuration, operating conditions, and flow schemes, where the pressure can be selected to maintain a gas phase holdup and superficial gas velocity within the reactor.

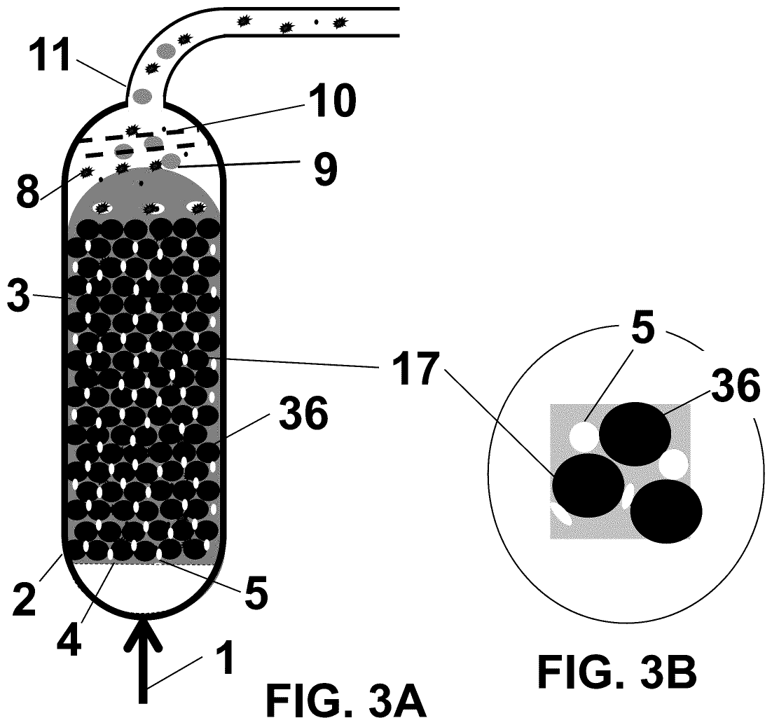

In another embodiment shown in FIG. 3A and FIG. 3B gas phase reactants 1 can be introduced into a reactor vessel or part of a reactor vessel 2 filled with a liquid media 3. The gas forms bubbles 5 by passing through a distributor plate, nozzle or set of nozzles, 4, which release the bubbles 5 into a packed bed of packing material 36. The bubbles can rise through the void spaces of the packed bed, which is filled with the liquid media 3. The reaction can proceed inside the gas bubbles 5, and produces solid products 8, which are prevented from contacting the solid surface of the packing material within the packed bed by a wetting layer 17 of the molten liquid media 3 adhering to the solid surface. The reaction proceeds and the reaction products exit the top of the liquid media 3. The reaction products are passed through a demister 10, which separates liquid droplets 9 entrained in the reaction products and returns the liquid media to the reactor. The reaction products leave the reactor through an exit 11.

The packing materials can be constructed from a material stable within the reaction environment and may be solid rolled or extruded with a smooth surface, formed as geometric shapes including tubes, spheres, and irregularly shaped bodies. The internal structures may also be perforated plates and combinations of perforated plates and geometric shapes alternatively, it may also be advantageous to use a woven, mesh, or otherwise made porous structures to facilitate wettability or specific applications. In some embodiments, the packing or structured materials can be made from tubes, sheets, woven wires, etc., of refractory materials including molybdenum, niobium, tantalum, tungsten, and/or rhenium and their alloys. In another embodiment, the packing material surfaces can be made from tubes, sheets, woven wires, etc., of metals, refractory metal-carbides, or oxides of Ni, Fe, Co, molybdenum, niobium, tantalum, tungsten and or/rhenium and their alloys. In some aspects, the materials can be made from ceramics containing, Al₂O₃, SiO₂, ZrO₃, MgO, or graphite. Combinations are also possible. For example, the materials used to form the packings can be formed from materials such as graphite or ceramics that are coated with the metals, oxides, or carbides such as a ceramic or graphite coated with tungsten carbide.

In some embodiments, the liquid is a molten metal containing one or more elements including Ag, Au, Sb, Sn, Bi, Ni, Cu, Fe, Pt, In, Pb, Pd, Co, Te, Rh and/or Ga, oxides thereof, and their mixtures. In some embodiments, the molten media 3 can comprise a molten salt, a molten metal, or any combination thereof. In some embodiments, the salt mixture comprises one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂), MgCl₂, CaBr₂, MgBr₂ and combinations thereof. In yet another embodiment, packing material can be prepared in-situ in the reactor by contacting the packing surfaces directly with oxygen or carbon in a solid, gaseous, or dissolved state, which is in direct contact with the molten liquid.

In another embodiment, the geometry, shape size, surface and open area of the packing materials or internal structures 36 can be varied to control the void fraction occupied by the liquid media 3 and gas bubbles 5 rising through the reactor vessel or reactor section 2. In another embodiment, the geometry, shape size, surface and open area of the packing materials or internal structures 36 can be varied to control the bubble rise velocity and residence time within a fixed length of reactor vessel or reactor section 2. In yet another embodiment, the geometry, shape size, surface and open area of the packing materials or internal structures 36 can be varied to control the axial mixing of the liquid medium within the reactor or reactor section, limiting mass and heat transfer and facilitating the establishment of thermal and concentration gradients with the liquid media 3.

In some embodiments the reactor vessel 2, can operate at suitable conditions for the desired reaction to occur. In some embodiments, the temperature can be selected to maintain the molten media 3 in the molten state such that the molten media 3 is above the melting point of the composition while being below the boiling point. In some embodiments, the reactor vessel 2 can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. In some embodiments, the reactor vessel 2, can be operated within any of the specified temperature ranges at one end of the reactor vessel 2 and another temperature within any of the specified temperature ranges at the other end of the reactor or reactor section by controlling the axial dispersion using packing materials. When small bubbles are desired, the reactor may operate at or near atmospheric pressure such as between about 0.5 atm and about 3 atm, or between about 1 atm and 2.5 atm. In other embodiments, the reactor may operate at higher pressures with an appropriate selection of the reactor configuration, operating conditions, and flow schemes, where the pressure can be selected to maintain a gas phase holdup and superficial gas velocity within the reactor.

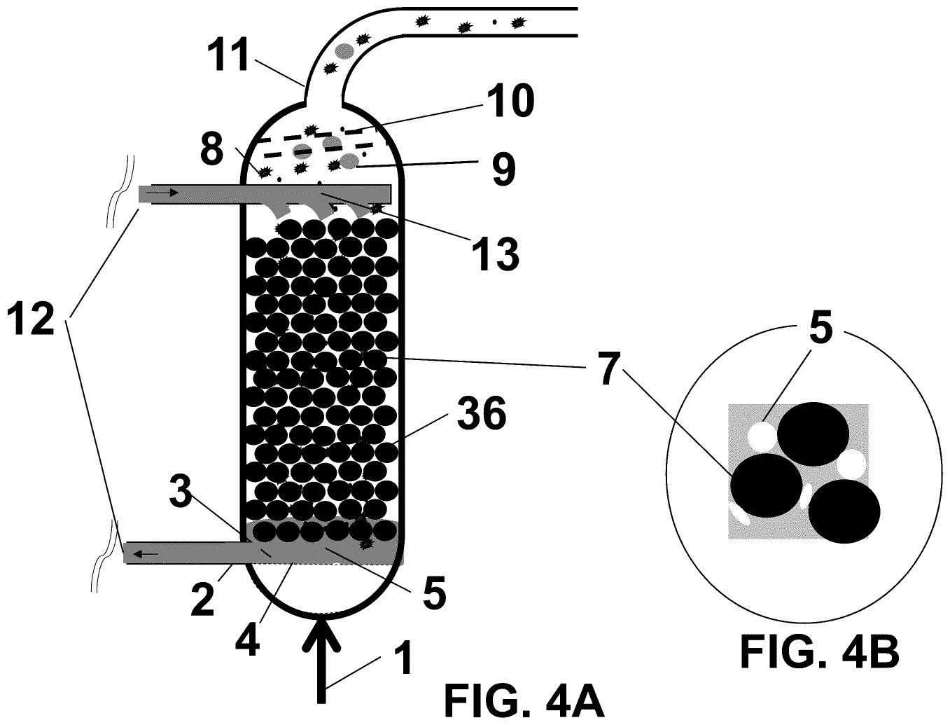

In another embodiment shown in FIG. 4A and FIG. 4B gas phase reactants 1 can be introduced into a reactor vessel or part of a reactor vessel 2 partially filled with a liquid media 3. The gas passes through a distributor plate, nozzle or set of nozzles 4 through a shallow pool of liquid media 3, which preheats the gas stream 5 before passing into a packed bed 36. The gas rises through the void spaces of the packed bed 36, contacting the down-coming liquid media 3 from the top of the reactor exchanging heat. The down-coming liquid media coats the packing 36, forming a thin film of a wetting layer of liquid 7 over the surface of the packing material 36. The reaction proceeds in the gas phase or on the surface of the liquid media 3 and produces solid products 8, which are prevented from contacting the solid surface of the packing material 36 by a wetting layer of liquid 7 adhering to the solid surface. The reaction proceeds and the reaction products are passed through a demister 10, which separates liquid droplets 9 entrained in the reaction products and returns the liquid media to the reactor. The reaction products leave the reactor through an exit 11. After exchanging heat to the incoming gas phase reactants 1, the liquid media is circulated out of the bottom of the reactor vessel 2 and returned to the top of the reactor vessel 2 via an external circulation loop 12. Heat can be added or removed from the liquid media 3 in the external circulation loop 12. The liquid media can be circulated by means of a pump or bubble lift. Whereas FIGS. 4A and 4B illustrate an implementation as a countercurrent trickle bed reactor, reactant gases may also be introduced in the top of the reactor to flow co-current to the down going liquid.

The packing materials can be constructed from a material stable within the reaction environment and may be solid rolled or extruded with a smooth surface, formed as geometric shapes including tubes, spheres, and irregularly shaped bodies. The internal structures may also be perforated plates and combinations of perforated plates and geometric shapes alternatively, it may also be advantageous to use a woven, mesh, or otherwise made porous structures to facilitate wettability or specific applications. In a preferred embodiment the packing or structured materials 36 can be made from tubes, sheets, woven wires, etc., of refractory materials including molybdenum, niobium, tantalum, tungsten, and/or rhenium and their alloys. In another embodiment, the packing material, 6, surfaces are made from tubes, sheets, woven wires, etc., of metals, refractory metal-carbides, or oxides of Ni, Fe, Co, molybdenum, niobium, tantalum, tungsten and or/rhenium and their alloys. In some aspects, the materials can be made from ceramics containing, Al₂O₃, SiO₂, ZrO₃, MgO, or graphite. Combinations are also possible. For example, the materials used to form the packing materials can be formed from materials such as graphite or ceramics that are coated with the metals, oxides, or carbides such as a ceramic or graphite coated with tungsten carbide.

In some embodiments, the liquid is a molten metal containing one or more elements including Ag, Au, Sb, Sn, Bi, Ni, Cu, Fe, Pt, In, Pb, Pd, Co, Te, Rh and/or Ga, oxides thereof, and their mixtures. In some embodiments, the molten media can comprise a molten salt, a molten metal, or any combination thereof. In some embodiments, the salt mixture comprises one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂), MgCl₂, CaBr₂, MgBr₂ and combinations thereof. In yet another embodiment, the packing material can be prepared in-situ in the reactor by contacting the packing surfaces directly with oxygen or carbon in a solid, gaseous, or dissolved state, which is in direct contact with the molten liquid.

In another embodiment, the packing material is specifically prepared by modification of the surface composition to provide a surface layer composed of a material that wets with the liquid. In one example, a metal is selected for the packing material in the presence of a liquid that insufficiently wets the surface of the pure metal. By chemical reaction of the metal to convert the surface of the metal to a modified composition, wetting is enhanced. For example, a metal that is not wetted by a liquid is reacted with a reactant containing nitrogen, carbon, oxygen, sulfur, or phosphorus, to form a surface layer of metal nitride, carbide, oxide, sulfide, or phosphide to form a surface interface that is now wetted.

In another embodiment, specific materials may be present in or added to the liquid to enhance wetting through interactions of the surface with the additives much like fluxes are used to prepare surfaces when soldering. In one specific example a corrosive metal oxide is present in the liquid that reacts with the previously unwetted solid material surface (which may itself have been modified) to form an interface that wets with the liquid. As an example, tin oxide present in molten tin at a temperature above 900° C. reacts with a solid tungsten and/or tungsten oxide surface to provide enhanced wetting of tungsten with the molten tin through the modified interface.

In yet another embodiment, the geometry, shape size and open area of the packing materials or internal structures 36 can be varied to control the available surface area covered by the liquid media 3 trickling down through the reactor or reactor vessel 2. In another embodiment, the geometry, shape size, surface and open area of the packing materials or internal structures 36 can be varied to control the superficial gas velocity and residence time within a fixed length of reactor or reactor vessel 2. In yet another embodiment, the geometry, shape size, surface and open area of the packing materials or internal structures 36 can be varied to control the rate of liquid decent through the column.

In some embodiments, the reactor vessel 2 can operate at suitable conditions for the desired reaction to occur. In some embodiments, the temperature can be selected to maintain the molten media 3 in the molten state such that the molten media 3, is above the melting point of the composition while being below the boiling point. In some embodiments, the reactor vessel 2 can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. The reactor can operate at any suitable pressure. When small bubbles are desired, the reactor may operate at or near atmospheric pressure such as between about 0.5 atm and about 3 atm, or between about 1 atm and 2.5 atm. In other embodiments, the reactor may operate at higher pressures with an appropriate selection of the reactor configuration, operating conditions, and flow schemes, where the pressure can be selected to maintain a gas phase holdup and superficial gas velocity within the reactor.

As disclosed herein, the molten media composition can be selected along with the composition of the surface so that the molten media wets the solid surface under the reaction conditions. The resulting liquid film can then prevent the formation of solid products on the solid surfaces. In some embodiments, the liquid may solvate and/or wash off any solid deposits formed on the solid surface in the event that a reactant directly contacts the solid surfaces during the reaction.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Preventing Coking of Solid Metal Surfaces in Molten Metal

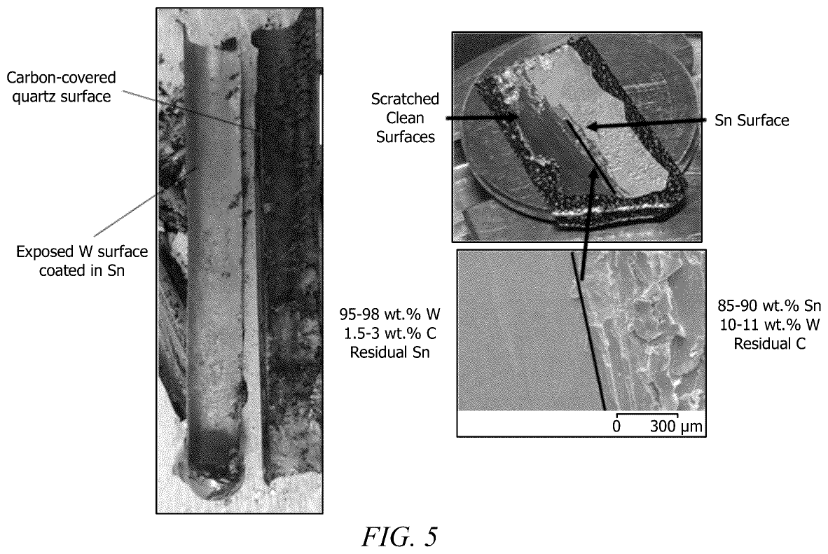

In a specific example, a quartz body molten tin bubble column at 1200° C. containing a half cylinder of tungsten through which methane is bubbled is operated for over 48 hours. Methane conversion is approximately 80% and, as seen in FIG. 5, carbon is observed to be deposited on the quartz surfaces contacting the methane, however, no solid carbon is observed to be deposited on the tungsten.

### Example 2

### Preventing Coking of a Solid Metal Surface in a Molten Metal

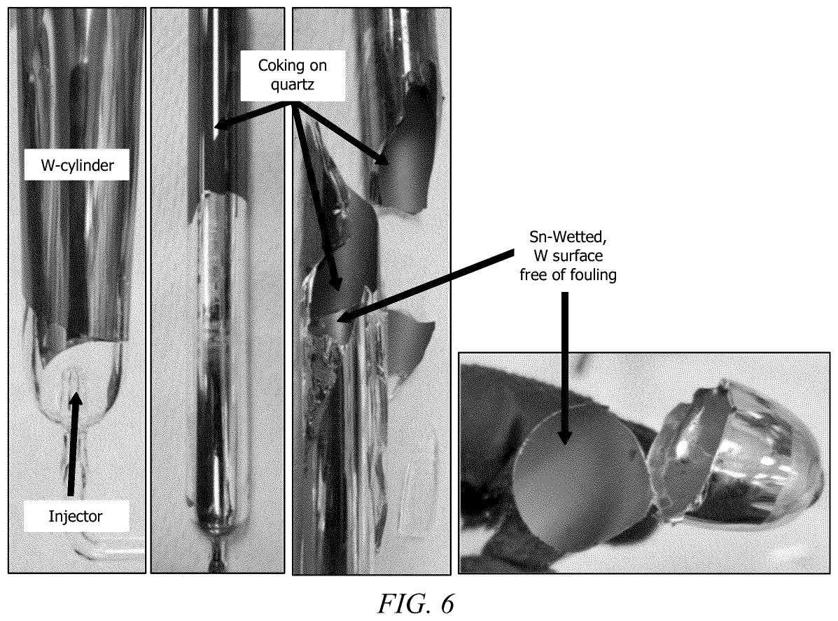

In another specific example, a quartz body molten tin bubble column at 1000° C. containing a full cylinder of tungsten through which methane is bubbled is operated for over 48 hours. Methane conversion is approximately 10% and, as seen in FIG. 6, carbon is observed to be deposited on the quartz surfaces contacting the methane, however, no solid carbon is observed to be deposited on the tungsten surface.

### Example 3

### Preventing Coking of Packing Material in a Molten Metal Bubble Column

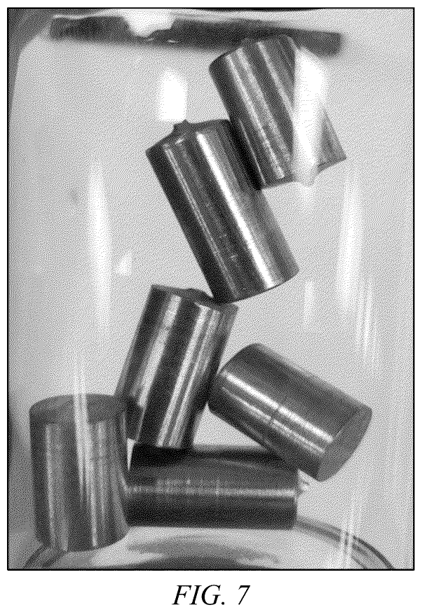

In another specific example, a molten tin bubble column maintained at 1200° C. is packed with 3 mm diameter cylindrical tungsten packing 5 mm in length and through which methane is bubbled for over 48 hours. Methane conversion is approximately 80%. Upon removal from the reactor, as seen in FIG. 7, the tungsten is observed to be wetted with tin and no carbon is observed to have been deposited.

### Example 4

### Preventing Coking of Solid Metal Surfaces in Molten Metal

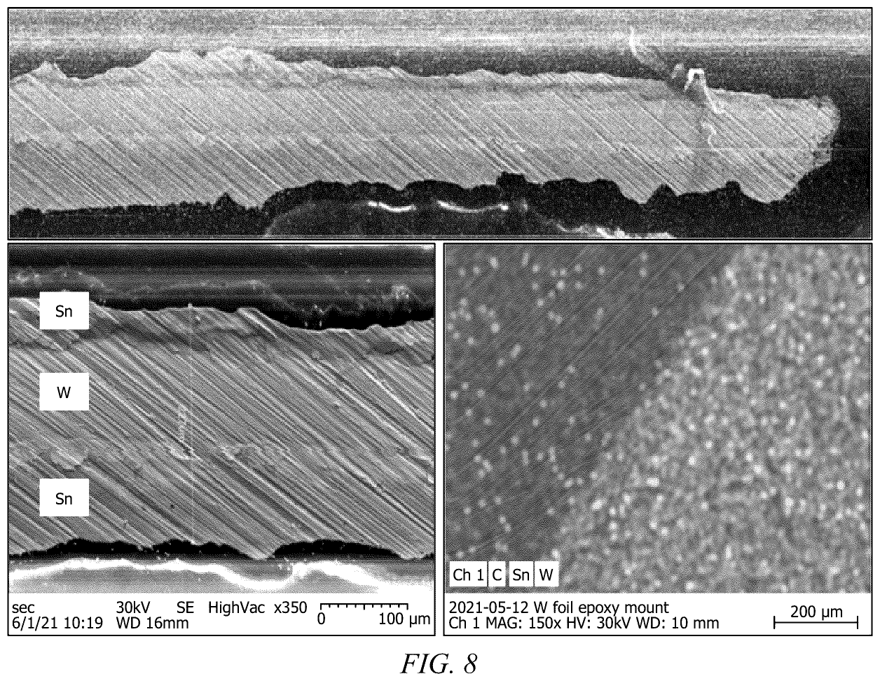

In another specific example, a quartz body molten tin bubble column at 800° C. containing a half cylinder of tungsten through which methane is bubbled is operated for over 48 hours. Methane conversion is <5% and, as seen in FIG. 8, carbon is observed to be deposited on the quartz surfaces contacting the methane, however, no solid carbon is observed to be deposited on the tungsten. Analysis of the W-foil edge shows a clear demarcation of W and Sn phases.

### Example 5

### Preventing Coking of Solid Metal Mesh Surfaces in Molten Metal

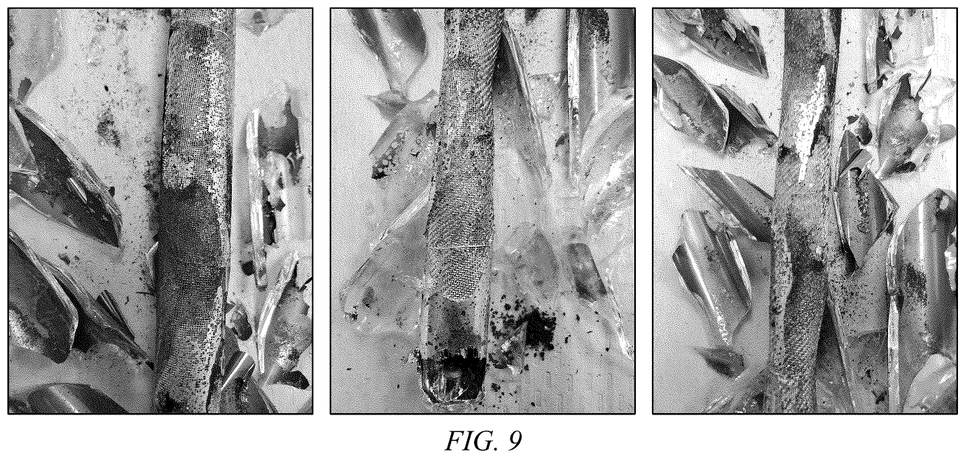

In another specific example, reference is made to FIG. 9 whereby a tungsten mesh screen was fashioned into a tube and lined the inside of a 1″ diameter quartz tube. The tube was filled with molten tin and methane bubbled through at 100 sccm at 1200° C. for 3 hours. After the reaction period the tube was drained and cooled in Argon. The tube was fractured to examine the contents and the inside surfaces of the mesh were observed to be wetted by tin and free of any carbon deposits whereas the quartz tube which was not wetted by tin where the mesh was absent and the gas phase methane contacted the surface was heavily coked with carbon.

### Example 6

### Preventing Carbon Deposition on Solid Metal Surface in Molten Metal

In another specific example, wetting of 4 mm 3 mm diameter tungsten metal pellets as packing within a 600 mm long bubble column is enhanced by the initial presence on the surface of the tungsten of a thin tungsten oxide layer. Whereas under certain conditions pure metallic tungsten is thought not to be sufficiently wetted by tin, with the tungsten oxide layer, and the presence of tin oxide impurities in the metal the interface reaction allows for wetting of the solid surface. When the bubble column is operated at 900° C. with 100 seem of pure methane the surface is fully wetted and no solid carbon is deposited on the packing.

### Example 7

### Preventing Carbon Deposition on Ceramic Bubble Column Reactor Lined with Molten Metal Wetted Draft Tube

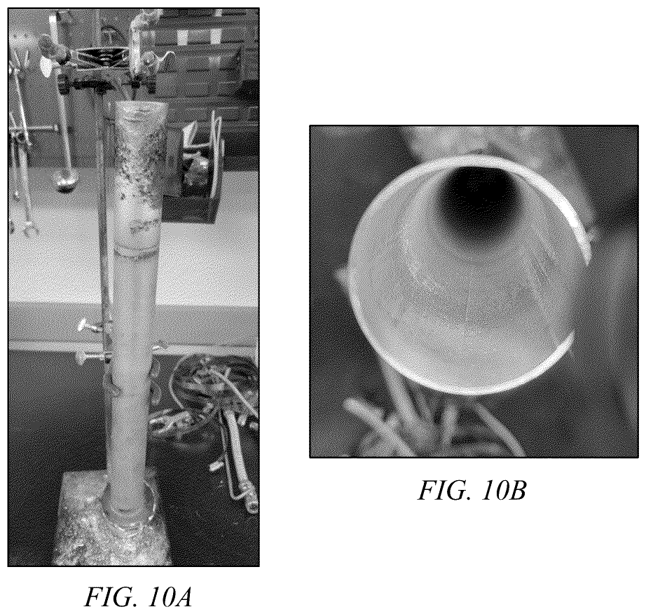

In another specific example, methane pyrolysis was continuously performed without carbon accumulation in a 2-inch diameter ceramic bubble column with a 24-inch tungsten tube inserted within the inner bore. The reactor was filled with tin to a total height of 36 inches and operated at a reaction temperature of 1150° C. with a pure methane feed flow rate of 1.1 standard liters per minute. The initial exposure of the tungsten to methane produced a surface layer of tungsten carbide which fully wetted with Sn. The reactor operated continuously without carbon accumulation on the draft tube walls for 8 hours. After draining the reactor, the draft tube is seen in FIGS. 10A and 10B to have no carbon accumulation or evidence of corrosion.

Having described various systems and methods, certain aspects can include, but are not limited to:

In a first aspect, a method for preventing deposition of solid reaction products from chemical reactions of reactants, reaction intermediates, or products on solid surfaces within chemical reactors comprises contacting a reactant with a selected liquid media within a reactor, wherein the liquid media does not react irreversibly with the reactant, reaction intermediates, or products to form products but is of a specific composition selected together with the materials comprising the solid surfaces within the reactor such that the liquid wets the surface of those solid surfaces within the reactor; and preventing production of solid reaction products on the solid surface, or washing off any produced products on the solid surfaces.

In a second aspect, a method for preventing coking and accumulation of solid carbon within reactors from decomposition of hydrocarbon containing reactants using high temperature liquids comprises molten salts and/or molten metals selected together with the materials of the reactor interior such that the reactor interior solid surfaces are wetted by a film of the high temperature liquid thereby preventing solid carbon deposition on the surfaces.

In a third aspect, a reactor for high temperature reactions of reactants comprises at least one containing carbon comprising a liquid media which itself does not react irreversibly with the reactant gases to form products but which wets the solid surfaces within the reactor with a film of the liquid media on which solid carbon produced in the reaction may be deposited and washed or removed from the solid surface.

In a fourth aspect, a bubble column reactor system for high temperature reactions of reactants comprises at least one that contains carbon filled with a high temperature liquid which itself does not react irreversibly with the reactants to form products but which wets the solid surfaces within the reactor with a film of the liquid media on which solid carbon produced in the reaction may be deposited and washed from the solid surface.

A fifth aspect can include the reactor system of the third or fourth aspects, whereby the reactor system is filled with a molten salt, a molten metal, or a mixture thereof and maintained at a temperature of at least 500° C.

A sixth aspect can include the reactor system of any one of the first to fifth aspects, whereby the reactor system is filled with a molten salt, molten metal, or a combination thereof comprising one or more of the following: (Na(I,Br,Cl,F), K(I,Br,Cl,F), Li(I,Br,Cl,F)) and/or (Ag, Au, Sb, Sn, Bi, Ni, Cu, Fe, Ga, Pb, In) and the solid internal surfaces of the reactor selected from one or more of the following materials (molybdenum, niobium, tantalum, tungsten, zirconium, aluminum, graphite, silicon, or rhenium), there oxides, carbides or combinations thereof, formed as smooth, porous, and/or woven materials.

A seventh aspect can include the reactor system of any one of the first to sixth aspects, 7whereby the reactor system is filled with a molten salt, a molten metal, or a combination thereof for high temperature reactions of hydrocarbons including alkanes, olefins, and aromatics at temperatures between 500° C. and 1700° C. whereby the internal structures within the reactor that come in contact with the rising gas bubbles are comprised of or coated with materials which are wetted by the molten media including but not limited to ceramics containing, Al₂O₃, SiO₂, ZrO₃, MgO, or metals containing Ni, Fe, Co, molybdenum, silicon, niobium, tantalum, tungsten, or rhenium, or graphite.

In an eighth aspect, a reaction process comprises contacting a reactant with a liquid reaction media in the presence of a solid surface, forming a solid reaction product based on the contacting; wetting the solid surface with the liquid reaction media; and preventing a formation of the solid reaction product on the solid surface based on wetting the solid surface with the liquid reaction media.

A ninth aspect can include the process of the eighth aspect, wherein the solid surface comprises a non-porous surface.

A tenth aspect can include the process of the eighth aspect, wherein the solid surface comprises a porous surface.

An eleventh aspect can include the process of the tenth aspect, wherein the porous surface comprises a mesh, a woven material, a filament based material, a screen, a perforated plate, or a combination thereof.

A twelfth aspect can include the process of any one of the eighth to eleventh aspects, wherein the reactant comprises a gas phase reactant, and wherein contacting the reactant with the liquid reaction media comprises guiding the gas phase reactant with the porous surface.

A thirteenth aspect can include the process of any one of the eighth to twelfth aspects, wherein the liquid reaction media comprises a molten metal comprising Ag, Au, Sb, Sn, Bi, Ni, Cu, Fe, Pt, In, Pb, Pd, Co, Te, Rh and/or Ga, oxides thereof, and any mixture thereof.

A fourteenth aspect can include the process of any one of the eighth to thirteenth aspects, wherein the liquid reaction media comprises a molten salt comprising one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃.

A fifteenth aspect can include the process of any one of the eighth to fourteenth aspects, wherein the solid surface is formed on at least one of a tube, a sphere, a saddle, a ring, a perforated plate, or an internal surface of a reactor vessel.

A sixteenth aspect can include the process of any one of the eighth to fifteenth aspects, wherein forming the solid reaction product comprises maintaining the liquid reaction media in a molten state at a temperature above about 400° C. and below about 1500° C.

A seventeenth aspect can include the process or system of any one of the first to sixteenth aspects, wherein the solid surface is prepared for wetting by chemical modification through a specific pre-treatment or exposure to material present in the liquid.

An eighteenth aspect can include the process or system of the seventeenth aspect, wherein the pre-treatment comprises forming an oxide, carbide, or other surface layer on the solid surface to improve wetting over the solid surface material wetting properties.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

1.-9. (canceled)

10. A bubble column reactor system comprising:
a reactor vessel;
a liquid media disposed within the reactor vessel;
an inlet disposed in a lower portion of the reactor, wherein the inlet is configured to introduce a feed gas comprising a reactant as bubbles within the liquid media, wherein the reactant comprising a compounds having carbon; and
a material disposed on at least a portion of a surface within the reactor vessel, wherein the material and the liquid media are selected so that the liquid media wets the material, wherein the material is an oxide or a carbide.

11. The bubble column reactor system of claim 10, further comprising:
a draft tube disposed within the reactor vessel, wherein the inlet is configured to introduce the feed gas as bubbles within an interior of the draft tube.

12. The bubble column reactor system of claim 10, further comprising:
a packing material disposed within the reactor vessel, wherein the inlet is configured to introduce the feed gas as bubbles passing through the packing.

13. The bubble column reactor system of claim 12, wherein at least the portion of the surface within the reactor vessel is formed on the packing material, and wherein the packing material comprises at least one of a tube, a sphere, a saddle, a ring, or a perforated plate.

14. The bubble column reactor system of claim 10, wherein at least the portion of the surface within the reactor vessel comprises a porous surface, and wherein the porous surface comprises a mesh, a woven material, a filament based material, a screen, a perforated plate, or a combination thereof.

15. The bubble column reactor system of claim 10, wherein the liquid media comprises a molten metal comprising Ag, Au, Sb, Sn, Bi, Ni, Cu, Fe, Pt, In, Pb, Pd, Co, Te, Rh and/or Ga, oxides thereof, and any mixture thereof.

16. The bubble column reactor system of claim 10, wherein the liquid media comprises a molten salt comprising one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃.

17. (canceled)

18. The bubble column reactor system of claim 10, wherein the material comprises: a ceramic, Al₂O₃, SiO₂, ZrO₃, MgO, a metal, Ni, Fe, Co, molybdenum, silicon, niobium, tantalum, tungsten, rhenium, or graphite, oxides thereof, carbides thereof, or any combination thereof.

19. The bubble column reactor system of claim 3 or 4, whereby the reactor system is filled with a molten salt, molten metal, or a combination thereof comprising Na(I,Br,Cl,F), K(I,Br,Cl,F), Li(I,Br,Cl,F), Ag, Au, Sb, Sn, Bi, Ni, Cu, Fe, Ga, Pb, In, wherein the material comprises molybdenum, niobium, tantalum, tungsten, zirconium, aluminum, graphite, silicon, rhenium, thereof oxides, carbides thereof, or combinations thereof.

20. A reaction process comprising:
contacting a reactant with a liquid reaction media in the presence of a solid surface, wherein the solid surface comprises an oxide or a carbide,
forming a solid reaction product based on the contacting;
wetting the solid surface with the liquid reaction media; and
preventing a formation of the solid reaction product on the solid surface based on wetting the solid surface with the liquid reaction media.

21. The process of claim 20, wherein the solid surface comprises a non-porous surface.

22. The process of claim 20, wherein the solid surface comprises a porous surface.

23. The process of claim 22, wherein the porous surface comprises a mesh, a woven material, a filament based material, a screen, a perforated plate, or a combination thereof.

24. The process of claim 20, wherein the reactant comprises a gas phase reactant, and wherein contacting the reactant with the liquid reaction media comprises guiding the gas phase reactant with the porous surface.

25. The process of claim 20, wherein the liquid reaction media comprises a molten metal comprising Ag, Au, Sb, Sn, Bi, Ni, Cu, Fe, Pt, In, Pb, Pd, Co, Te, Rh and/or Ga, oxides thereof, and any mixture thereof.

26. The process of claim 20, wherein the liquid reaction media comprises a molten salt comprising one or more oxidized atoms (M)^{+m} and corresponding reduced atoms (X)⁻¹, wherein M is at least one of K, Na, Mg, Ca, Mn, Zn, Fe, La, or Li, and wherein X is at least one of F, Cl, Br, I, OH, SO₃, or NO₃.

27. The process of claim 20, wherein the solid surface is formed on at least one of a tube, a sphere, a saddle, a ring, a perforated plate, or an internal surface of a reactor vessel.

28. The process of claim 10, wherein forming the solid reaction product comprises maintaining the liquid reaction media in a molten state at a temperature above about 400° C. and below about 1500° C.

29. The process of claim 20, wherein the solid surface is prepared for wetting by chemical modification through a specific pre-treatment or exposure to a material present in the liquid, and wherein the pre-treatment comprises forming the oxide, the carbide, or other surface layer on the solid surface to improve wetting over the solid surface material.

30. (canceled)

31. The process of claim 20, wherein the reactant comprises a gas, where the process further comprises:
introducing the reactant into the liquid reaction media to form bubbles;
guiding the bubbles within the liquid reaction media using a draft tube disposed within a reactor vessel, wherein the solid surface comprises at least a portion of the draft tube.

32. The process of claim 31, wherein the solid surface comprises ceramic, Al₂O₃, SiO₂, ZrO₃, MgO, a metal, Ni, Fe, Co, molybdenum, silicon, niobium, tantalum, tungsten, rhenium, or graphite, oxides thereof, carbides thereof, or any combination thereof.
